(19) United States
(12) Patent Application Publication
(10) Pub. No.: US 2020/0254644 A1
(43) Pub. Date: Aug. 13, 2020

(54) Rotary Die Cutting System

(71) Applicant: WINK Stanzwerkzeuge GmbH & Co. KG, Neuenhaus (DE)

(72) Inventor: Albertus de Natris, Nordhorn (DE)

(21) Appl. No.: 16/649,635

(22) PCT Filed: Sep. 20, 2018
(86) PCT No.: PCT/EP2018/075515

§ 371 Date: Mar. 21, 2020

(30) Foreign Application Priority Data
Sep. 22, 2017 (DE) 10 2017 122 072.0

(51) Int. Cl. B26F 1/38; B26D 7/26

(52) U.S. Cl. CPC B26F 1/384; B26F 1/44; B26D 7/265

(57) ABSTRACT

A rotary die cutting system comprising: a rotary die cutter (21) having a die cutting cylinder (22) that can rotate about a die cutting axis; a counter-pressure cylinder (23) that can rotate about a counter-pressure cylinder axis; and an adjusting mechanism, by means of which a gap width between the die cutting cylinder and the counter-pressure cylinder (22, 23) can be adjusted; and a die cutting sheet (25) that can be fixed to the die cutting cylinder (22). A machine-readable information carrier (26) is associated with the die cutting sheet (25), more particularly the die cutting sheet (25) has said information carrier, by means of which carrier at least the die cutting sheet (25) can be identified, and the rotary die cutting system has a detection unit (27) designed to read out the information carrier (26). The adjusting mechanism has a servomotor and a control unit (28) and is designed to adjust the gap width according to the die cutting sheet (25). Also disclosed is a method for adjusting the gap width.

The invention concerns a rotary die cutting system comprising a rotary die cutting device with a die cutting cylinder that is rotatable about a die cutting cylinder axis and with a counter pressure cylinder that is rotatable about a counter pressure cylinder axis as well as with an adjusting device by means of which a gap width between die cutting cylinder and counter pressure cylinder is adjustable as well as a die cutting sheet that can be fixed at the die cutting cylinder.

Such rotary die cutting systems are known in the prior art. For example, DE 10 2013 110 510 A1 discloses a device for rotary die cutting, with a die cutting cylinder that is used with a die cutting tool in the form of a die cutting sheet in which the gap width between die cutting cylinder and counter pressure cylinder is adjustable.

A dimension of 480 μm has been developed as a quasi industrial standard for the gap width between die cutting cylinder and counter pressure cylinder. When die cutting, the die cutting edges of the die cutting sheet fixed on the die cutting cylinder are to penetrate the material to be die cut as much as possible in order to ensure a good die cutting result and a simple separation of the region to be die cut from the rest of the material. At the same time, it must however be prevented that the die cutting edges come into contact with the counter pressure cylinder because these components would otherwise be damaged. In order to ensure this, the gap width between die cutting cylinder and counter pressure cylinder is configured to be adjustable. Thus, manufacturing tolerances of the die cutting cylinder or of the counter pressure cylinder as well as manufacturing tolerances of the die cutting sheet can be taken into account. Furthermore, a readjustment of the gap width upon wear of the relevant components of the die cutting device or in case of wear of the die cutting sheet are required. The adjustment of the gap width must be possible very precisely in order to ensure a good die cutting result and prevent at the same time damage of the rotary die cutting device or of the die cutting sheet. In order to ensure a good die cutting result, the gap width is adjusted, for example, in a range of 1/10 μm. Since different die cutting sheets as a result of manufacturing tolerances have different dimensions and therefore require different gap widths, the adjustment of the gap width is individually required for each die cutting sheet. The die cutting cylinder is to be understood here as the cylinder at which the die cutting sheet is fixed. In the prior art, the use of a magnetic cylinder as die cutting cylinder has gained acceptance.

Object of the present invention is to provide a rotary die cutting system, an associated die cutting sheet as well as a method for adjusting the gap width of the rotary die cutting system in which the gap width adjustment is realized in a simpler and in particular more reliable way and thus damage of the rotary die cutting device and/or of the die cutting sheet is avoided as much as possible.

The object is solved by an article according to claim 1, a method according to claim 15, and an article according to claim 23. Advantageous embodiments of the invention can be taken from the dependent claims depending from these claims as well as the following description.

According to the invention, the object is solved by a rotary die cutting system in which a machine-readable information carrier is assigned to the die cutting sheet by means of which the die cutting sheet can be at least identified and the rotary die cutting system comprises a detection unit for reading the information carrier wherein the adjusting device comprises a servomotor and a control unit and is configured for adjusting the gap width as a function of the die cutting sheet. By the identification of the die cutting sheet by means of the machine-readable information carrier which is assigned to the die cutting sheet and in particular is arranged at the die cutting sheet or is formed by it, the adjustment of the gap width can be adjusted to a value which is suitable precisely for this die cutting sheet or at least a suitable starting value for this die cutting sheet from which then only comparatively minimal adaptations of the gap width for reaching an optimal die cutting result are required. In this context, the adjustment of the gap width by the use of a multi-part adjusting device can also be realized such that the spacings between die cutting cylinder and counter pressure cylinder at both sides of the cylinders is realized differently. This is in particular advantageous in case of non-uniform wear of the die cutting sheet in operation. The tooling of the rotary die cutting system is realized faster. At the same time, in this context a damage of the die cutting sheet or of the rotary die cutting device can be prevented when the adjustment of the gap width is realized such that a contact between die cutting edges of the die cutting sheet and the counter pressure cylinder can be safely adequately prevented.

In a preferred embodiment, the information carrier and the detection unit are configured for communication by radio, in particular near field radio, for example, Bluetooth, radio frequency identification or near field communication. The communication by radio between information carrier and detection unit is comparatively little failure-prone. In addition, greater data quantities can be transmitted in a comparatively simple way by radio. In this way, the die cutting sheet can be reliably identified and an adjustment of the gap width matching this die cutting sheet can be carried out.

In an alternative preferred embodiment, the detection unit is configured as an optical detection unit, in particular as a camera, and the information carrier is configured as an optically readable information carrier, in particular as QR code. Thus, by recording an image of the information carrier, the die cutting sheet can be identified. An optically readable information carrier is technically producible in a very simple way and can be, for example, glued on, punched, introduced by a laser, or etched. The information carrier can be configured, for example, as a string of digits, bar code, or multi-dimensional pattern. Particularly preferred, the optically readable information carrier is configured as a QR code. In the QR code, comparatively much information can be accommodated again within a compact space. Due to the automatic error correction inherent to the QR code, the identification of the corresponding die cutting sheet provided with the QR code is very robust. In this way, the corresponding die cutting sheet can be identified very reliably and a gap width suitable for this die cutting sheet can be adjusted.

Advantageously, the information carrier is configured as a structure which is introduced into the surface material of the die cutting sheet, in particular etched or introduced by laser. In this way, a fixed connection between information carrier and die cutting sheet is formed. The information carrier cannot be detached from the correlated die cutting sheet or become accidentally detached. Thus, the die cutting sheet can be reliably identified by means of the information carrier. The risk of a mix-up of the information carrier with a die cutting sheet that is different than the correlated one can thus be minimized.

Preferably, the adjusting device is configured such that it automatically adjusts a gap width which is suitable for the die cutting sheet provided with the information carrier. In this context, the detection of the gap width which is suitable for the die cutting sheet as well as the adjustment of this gap width by means of the adjusting device is carried out automatically, in particular without additional human intervention. In this context, it is ensured that indeed the gap width that is suitable for the die cutting sheet is adjusted. The risk of human error when adjusting the gap width is minimized. Moreover, the ease of use of the rotary die cutting system for the operator is increased because, aside from fixing the die cutting sheet on the die cutting cylinder and initiating reading of the information carrier, no further actions for adjusting the gap width must be performed.

Preferably, the rotary die cutting system comprises a memory, in particular in the control unit, which is configured to store the information of the die cutting sheet which is read out by the detection unit, in particular the identification, as well as the gap width adjustment effected by the adjusting device. With such a memory, the determination of a gap width that is suitable for the die cutting sheet and that is stored together with the identification of the die cutting sheet in the memory is simplified. This is in particular advantageous when the use of the die cutting sheet leads to wear thereof. This can impair the die cutting result so that a readjustment, in particular reduction of the gap width, is required in order to obtain again an acceptable die cutting result. This new smaller gap width can then be retrieved upon renewed use of the die cutting sheet when it is fixed again on the die cutting machine.

Further information that can be stored in the memory in connection with the identification of the die cutting sheet is the number of die cutting processes performed with this die cutting sheet, the wear of the die cutting sheet, and/or the history of the gap width changes for the die cutting sheet. In this way, for example, it is possible to derive information in regard to the service life of the die cutting sheet or, in the context of predictive maintenance, the production of a replacement die cutting sheet can be initiated in due time.

Preferably, the rotary die cutting system comprise an operating unit with an input unit and a display unit which preferably are combined in a touch screen. The operating unit can serve in this context as a display and input unit for the control system. Alternatively, the operating unit can comprise a microprocessor and a memory unit and the control system can be integrated in the operating unit. The operating unit can comprise in this context the memory in which the information of the die cutting sheet as well as the gap width adjustment effected by the adjustment can be stored, and/or comprises a memory which is independent therefrom. By means of the operating unit, the gap width adjustments can be displayed to the operating personnel of the rotary die cutting system so that they can be checked again by the operating personnel. By means of the operating unit, the operating personnel can carry out manual changes of the gap width adjustment as they are required, for example, when the die cutting result is not satisfactory. These changes are then implemented by means of the control device and the servomotor in a precise change of the gap width by means of the adjusting device. In this way, a reliable and precise adjustment of the gap width of the rotary die cutting system is enabled.

Particularly preferred, the operating unit is connected movably with the rotary die cutting system and/or is mobile. In particular, the operating unit is preferably movably connected by means of a flexible cable to the rotary die cutting system. In this way, the operator can position himself freely relative to the rotary die cutting device to a certain degree. The operation of the rotary die cutting system is simplified. This is realized as much as possible in an advantageous way in case of a completely mobile operating unit that is connected, for example, via a radio connection with the rotary die cutting device and comprises an independent energy supply, for example, in the form of a rechargeable battery.

Particularly preferred, the detection unit is arranged in the operating unit. In this way, the detection unit can be moved to the machine-readable information carrier of the die cutting sheet and the latter can be read out. In this way, the operation of the rotary die cutting system for adjusting the gap width is simplified.

Preferably, the control unit and the operating unit arranged separately therefrom are configured for synchronization of die cutting sheet-specific data. For this purpose, the control unit as well as the operating unit each have their own memory assigned to them. Die cutting sheet-specific data which are stored in the memory of the control unit or of the operating unit are synchronized when control unit and operating unit are connected to each other. As a result, these data are then present in the control unit as well as in the operating unit. In this way, an automatic backup of the relevant data is carried out. The data are thus present redundantly so that when the control unit or the operating unit or the respectively assigned memories fail, the defective component can be exchanged without this leading to data loss. After exchange, the data are synchronized and installed in the new control unit or the new operating unit. The risk of a loss of the die cutting sheet-specific data is thus reduced in this way and ensured that an adjustment of the gap width to a die cutting sheet-specific value is possible with high availability. As a supplement or as an alternative, a data set can be stored on an external database which is connected by means of communication means.

Preferably, the rotary die cutting system comprises at least one additional rotary die cutting device. In this context, the rotary die cutting system is configured such that, by reading the information carrier of the die cutting sheet, a repeated use of this die cutting sheet can be recognized and, depending on the gap width adjustment on the rotary die cutting system on which the die cutting sheet has been used last which is stored in the memory, a suitable gap width can be automatically adjusted by means of the control device of the rotary die cutting machine that is to be used now with the die cutting sheet. By use of such a rotary die cutting system it is possible to ensure a die cutting sheet-specific gap width adjustment even for use of the die cutting sheet on more than one rotary die cutting device. In this context, changes of the gap width which have been carried out at a different rotary die cutting device with upon use of this die cutting sheet can be taken into account for use on a further rotary die cutting device. This simplifies the use of a die cutting sheet for a plurality of rotary die cutting devices and enables the precise adjustment of the optimal die cutting sheet-specific gap width, respectively, independent of the rotary die cutting device.

Particularly preferred, the rotary die cutting system comprises at least one additional memory wherein the memories are linked at least temporarily with each other. The different memories in this context are preferably assigned to a rotary die cutting device, respectively, or are part of different operating units. By temporary linking of these memories, a synchronization of the die cutting sheet-specific data stored in the memories is taking place. Thus, upon renewed use of a die cutting sheet, the data of the last use can be retrieved, respectively, independent of on which rotary die cutting device this took place. By the use of a plurality of memories, redundancy of these data is provided. The risk of a data loss is minimized. Particularly preferred, this can be realized by use of a memory which is assigned to one of the rotary die cutting devices as well as a memory assigned to the operating unit. When connecting the operating unit with the rotary die cutting device, these memories are at least temporarily linked with each other, and a synchronization and optionally an exchange of the die cutting sheet-specific data stored therein can be realized. The operating unit can now be connected to a further rotary die cutting device wherein the data are transmitted by means of the memory of the operating unit from the memory of one die cutting device to the memory of a further die cutting device.

The object is further solved by a method for adjusting the gap width between a die cutting cylinder and a counter pressure cylinder of a rotary die cutting device of the afore described rotary die cutting system, wherein a machine-readable information carrier of a die cutting sheet to be employed is read, a gap width is determined that is suitable for the die cutting sheet to be employed, and the gap width is adjusted. By reading the machine-readable information carrier of the employed die cutting sheet, this die cutting sheet is identified. In the following, a gap width is determined which is suitable for this die cutting sheet. In this context, various factors can be taken into account. Subsequently, the suitable gap width is adjusted in order to ensure reliable function of the die cutting sheet on the rotary die cutting device. Here also, different gap widths at the respective ends of die cutting cylinder and counter pressure cylinder can be adjusted. In this way, a non-uniform wear of the die cutting sheet can be taken into account. This The method simplifies thus the adjustment of a gap width suitable for a die cutting sheet in that the die cutting sheet is identified unambiguously and reliably.

Particularly preferred, from the information carrier at least one identification of the die cutting sheet and/or information in regard to a standard gap width and/or information in regard to a standard die cutting cylinder with circumference, number of teeth, and/or toothing are read out. In this way, the die cutting sheet can be identified. In addition, a standard gap width for which this die cutting sheet has been manufactured as well as the manufacturing tolerances can be stored on the information carrier. This standard gap width serves as a starting point for the adjustment of a suitable gap width. In order to avoid damage of the rotary die cutting device or of the die cutting sheet, preferably the manufacturing tolerances are additionally taken into account. When no additional information for the determination of the gap width to be used for this die cutting sheet is available, this information is a sufficient starting point for determining the suitable gap width. Moreover, the information carrier can contain information regarding for which type of die cutting cylinder, the standard die cutting cylinder, the die cutting sheet is configured. The die cutting cylinders differ in this context in particular with regard to their circumference. The circumference can be determined either directly or by means of the number of teeth of a toothed wheel of the die cutting cylinder or further information about the toothing of the die cutting cylinder. Thus, at least the most necessary, preferably however also further useful information for determining a suitable gap width is available.

Preferably, the method comprises the use of a database, in particular with information in regard to one or a plurality of die cutting sheets. In this context, also further information, in particular dynamic information that changes over the course of time can be stored in regard to the one or the plurality of die cutting sheets and can be used for the determination of a suitable gap width. The determination of the suitable gap width and thus also the adjustment of a suitable gap width can be improved by use of a database whose information, in contrast to the information on the information carrier, can be adapted in a simple way to changed conditions.

Particularly preferred, the database is searched for information about the employed die cutting sheet as well as the gap width which has been adjusted last for this die cutting sheet. Then, either the gap width used last for this die cutting sheet and stored in the database or, on the other hand, when no entry for the employed die cutting sheet is present in the database, a standard gap width, in particular a standard gap width stored in the information carrier, is used for determining a suitable gap width and for adjusting the gap width. In this way, the determination of a suitable gap width can be improved and at the same time it is ensured that, in any case, a gap width that is assumed to be safe is adjusted.

Preferably, the combination of employed die cutting sheet and gap width used last for this die cutting sheet is stored in the database. In this way, the gap width used last can be retrieved, based on the identification of the die cutting sheet, from the database for future uses. Preferably, the changes of the gap width over the course of time are stored in the database wherein the respectively last employed gap width value is used as a basis for the adjustment of a suitable gap width for the renewed use of the corresponding die cutting sheet. Based on the historical data, a course of wear of the die cutting sheet can also be derived in this context, for example, and these data can be used for timely initiation of the manufacture of a new die cutting sheet.

Preferably, the die cutting cylinder used in the rotary die cutting device is identified wherein either for each rotary die cutting device at least an information regarding the currently used die cutting cylinder, in particular the die cutting cylinder diameter and/or the number of teeth and/or the toothing, is stored and is automatically made available, or the die cutting cylinder is manually selected. Since the die cutting sheets are usually manufactured for the use on a defined type of die cutting cylinder, i.e., in particular for a die cutting cylinder with a defined diameter and with a defined gap width, a corresponding comparison whether the rotary die cutting device, considered for use with the corresponding die cutting sheet, comprises such a die cutting cylinder is advantageous. Should the die cutting cylinder present in the rotary die cutting device deviate in regard to gap width and/or diameter, which can also be indirectly determined via other data such as number of teeth or information in regard to the toothing, from the standard die cutting cylinder for which the die cutting sheet has been manufactured, this deviation can be taken into account when determining a suitable gap width. The information in regard to the die cutting cylinder used in the rotary die cutting device can be stored, for example, in the control device. This is possible either when the rotary die cutting device is used exclusively with the corresponding die cutting cylinder. In this case, the corresponding information can be stored permanently. Otherwise, the information can be updated to the corresponding actual state when exchanging the die cutting cylinder in the rotary die cutting device.

In a further advantageous embodiment, when no information is stored in regard to the die cutting cylinder in the system, the die cutting cylinder can be selected manually. For this purpose, an operator can either select from a list of die cutting cylinders the die cutting cylinder which is currently installed in the die cutting device or the operator inputs directly the relevant data such as die cutting cylinder diameter, toothing and/or gap width into the rotary die cutting system.

Preferably, a nominal gap width of the employed die cutting cylinder is stored and is compared with the standard gap width of the die cutting sheet. When there is a difference between the two gap widths, the calculation of the required correction of the gap width to be adjusted is carried out. In this way, such a difference can be taken into account in a way that is simple, little error-prone, and primarily user-friendly. The use of a die cutting sheet on a rotary die cutting device with a die cutting cylinder which is deviating from the specification is thus facilitated. The flexibility of the rotary die cutting system is increased.

Preferably, for adjusting the gap width, a die cutting cylinder-specific driving curve is used. This die cutting cylinder-specific driving curve is in particular retrieved from a die cutting cylinder database. In the driving curve, for example, value pairs of gap width and motor position or of gap width and the corresponding motor control signal are stored. They can be individually stored for each die cutting cylinder and for different adjusting devices and can be subjected also to changes over time, for example, by wear. By the use of corresponding die cutting cylinder-specific driving curves, the gap width can be adjusted very precisely depending on the employed die cutting cylinder. In this way, the reliability of a corresponding rotary die cutting system is increased and the probability of errors and damage of the rotary die cutting device is minimized. Particularly preferred, the control signal which is required for adjusting the gap width for the servomotor is retrieved from the driving curve or is determined by means of interpolation from neighboring values and transmitted to the servomotor. When in the driving curve a discrete value pair is stored for the gap width to be adjusted, the value can be employed by the control system that is stored for this gap width for motor position, control signal or other specifications useable for adjusting the gap width. When the value pair that is required for the gap width to be adjusted is not directly stored in the driving curve, the value to be adjusted can be determined by means of an in particular linear interpolation based on the neighboring values of the driving curve. Such a driving curve can also serve to linearize a transmission that is initially different, due to different angle positions of an eccentric of the counter pressure cylinder, in that the adjusting device is provided with an adjusting curve which predetermines an adjustment as a function of the angle position.

Preferably, when determining the gap width to be adjusted, in particular a user-defined safety allowance is taken into account. The safety allowance can be embodied here as a percentage or absolute value. This value can be predetermined by a user, for example, the machine operator. The value is taken into account when calculating the gap width to be adjusted, for example, is added at the end to the determined gap width that is to be adjusted. When, for example, the gap width of the last use of the corresponding die cutting sheet on a rotary die cutting machine is to be adjusted as a gap width, a user-defined allowance can be carried out so that a somewhat larger gap width is adjusted. Based on this value, an operator can adjust then manually, based on the die cutting result, such a gap width that leads to a desired die cutting result. In this way, it is ensured, on the one hand, that the change of the gap width, which, for example, is automatically pre-adjusted, toward the gap width that produces in operation the desired die cutting result is minimal. On the other hand, by the addition of the safety allowance, the danger is reduced that, upon start of operation of the rotary die cutting device with the die cutting sheet newly fixed thereon, a contact between the die cutting edges of the die cutting sheet and the counter pressure cylinder takes place and thus damage of the rotary die cutting device occurs. The operational safety of the corresponding rotary die cutting system is thus increased by the use of a safety allowance.

The initially indicated object is also solved by a die cutting sheet with an information carrier that can be employed in a device described above or in the following and/or in a method described above or in the following.

Further advantageous configurations of the invention will be explained in more detail with the aid of the embodiment described in the following. It is shown therein:

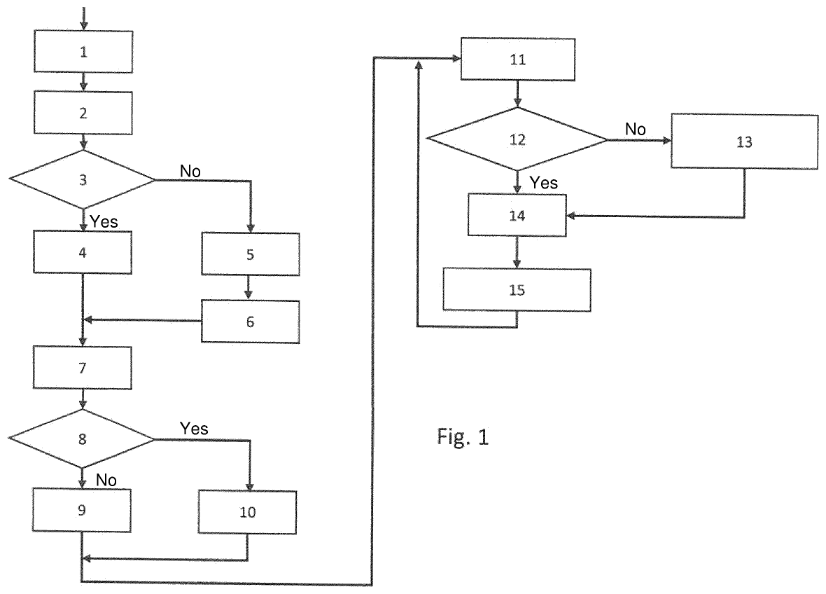

FIG. 1 a flowchart of a method according to the invention;

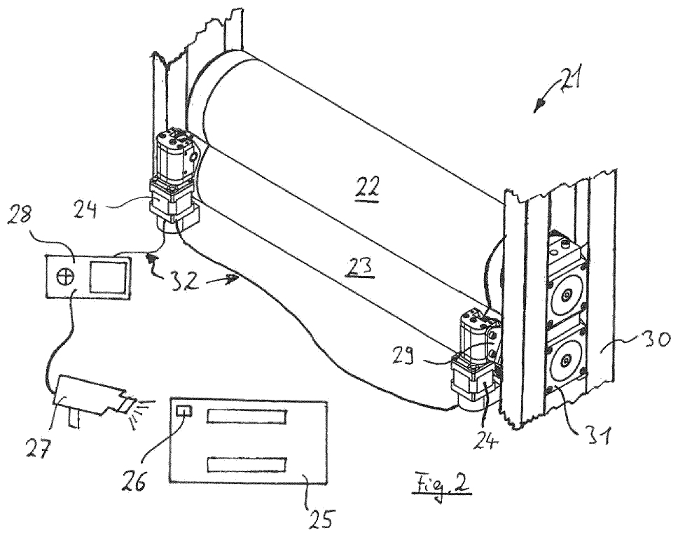

FIG. 2 a schematic partially perspective illustration of an article according to the invention.

In the following, elements of the invention acting in the same way are provided with the same reference number, inasmuch as this is expedient. The features of the embodiment described in the following can also be subject matter of the invention in other feature combinations than illustrated.

FIG. 1 shows a method according to the invention. In a first method step 1, the machine-readable information carrier 26 which is provided at the die cutting sheet 25 is read out by the detection unit 27. In method step 2, the die cutting cylinder 22 which is to be used with the die cutting sheet 25 is identified. For this purpose, it is checked in step 3 whether information in regard to the die cutting cylinder 22 exists. When this is the case, the data in regard to the die cutting cylinder 22 are retrieved and the die cutting cylinder 22 identified in step 4. When, on the other hand, no data in regard to the die cutting cylinder 22 are existing, the message “die cutting cylinder not present” is deployed in step 5. Subsequently, a manual selection of the die cutting cylinder 22 to be used is made in step 6. In step 7, a cylinder-specific driving curve is loaded. In step 8, it is checked whether information in regard to prior use of the corresponding die cutting sheet 25 exists. When this is not the case, a standard gap width that is, for example, stored in the information carrier 26 is adjusted in method step 9. When a prior use of the die cutting sheet 25 is documented, the last used gap width is used for gap width adjustment in the method step 10. In step 11, the gap width to be adjusted is calculated. In this context, for example, a safety allowance is used. In step 12, it is checked whether for this gap width a corresponding value pair with the required control signal is stored in the driving curve. When this is not the case, at least a preceding and a following value in the driving curve are determined in step 13 and the searched-for control signal is calculated by interpolation, preferably linear interpolation. In the method step 14, the determined control signal is transmitted to the servomotor and the gap width is adjusted. The now adjusted position is stored in a database together with at least the identification of the die cutting sheet.

According to FIG. 2, a rotary die cutting system according to the invention comprises a rotary die cutting device 21, with a die cutting cylinder 22 that is rotatable about a die cutting cylinder axis, not identified in detail by number, as well as with a counter pressure cylinder 23 that is rotatable about a counter pressure cylinder axis (also not identified by number) as well as with a multi-part adjusting device with actuating means 24 by means of which a gap width between die cutting cylinder and counter pressure cylinder can be adjusted. Moreover, the rotary die cutting system comprises a die cutting sheet 25 that can be fixed on the die cutting cylinder. The die cutting sheet 25 comprises a machine-readable information carrier 26 which is configured here as QR code which can be detected by an optical detection unit 27 which here is embodied as a camera. Moreover, the adjusting device comprises a control unit 28 which carries out data processing and the control of the actuating means 24 comprising servomotors. The actuating means 24 are secured respectively by flange means 29 directly in the sides of the rotary die cutting device 21 in slide blocks 31 guided in a frame 30. The control of the actuating means 24 is realized by cable 32 but can also be done wireless, however. The same holds true also for detecting the information carrier 26 which can also be embodied, for example, as an RFID tag.

What is claimed is:

1.-23. (canceled)

24. A rotary die cutting system comprising:
one or more die cutting devices each comprising:
a die cutting cylinder rotatable about a die cutting cylinder axis,
a counter pressure cylinder rotatable about a counter pressure cylinder axis, and
an adjusting device configured to adjust a gap width between the die cutting cylinder and the counter pressure cylinder;
a die cutting sheet configured to be fixed on the die cutting cylinder, wherein the die cutting sheet comprises a machine-readable information carrier configured to at least provide an identification of the die cutting sheet;
a detection unit configured to read out the information carrier;
wherein the adjusting device comprises a servomotor and a control unit and is configured to adjust the gap width based on the die cutting sheet.

25. The rotary die cutting system according to claim 24, wherein the information carrier and the detection unit are configured to communicate with each other by radio.

26. The rotary die cutting system according to claim 24, wherein the detection unit is an optical detection unit and the information carrier is an optically readable information carrier.

27. The rotary die cutting system according to claim 26, wherein the optical detection unit is a camera and the information carrier is a QR code.

28. The rotary die cutting system according to claim 24, wherein the information carrier is a structure introduced into a surface material of the die cutting sheet.

29. The rotary die cutting system according to claim 28, wherein the structure is etched or introduced by laser into the surface material of the die cutting sheet.

30. The rotary die cutting system according to claim 24, wherein the adjusting device is configured to automatically adjust the gap width based on the die cutting sheet.

31. The rotary die cutting system according to claim 24, further comprising a memory configured to store information of the die cutting sheet.

32. The rotary die cutting system according to claim 31, wherein the information stored in the memory is the identification of the die cutting sheet, read out from the information carrier by the detection unit, and a gap width adjustment of the gap width effected by the adjusting device.

33. The rotary die cutting system according to claim 31, wherein the memory is provided in the control unit.

34. The rotary die cutting system according to claim 24, further comprising an operating unit comprising an input unit and a display unit.

35. The rotary die cutting system according to claim 34, wherein the operating unit is connected movably with the rotary die cutting system or is mobile.

36. The rotary die cutting system according to claim 35, wherein the detection unit is arranged in the operating unit.

37. The rotary die cutting system according to claim 34, wherein the control unit and the operating unit that is separately arranged relative to the control unit are configured to synchronize die cutting sheet-specific data among each other.

38. The rotary die cutting system according to claim 24, further comprising a first memory configured to store information of the die cutting sheet, wherein the rotary die cutting devices are configured such that, by reading the information carrier, a repeated use of the die cutting sheet is detectable and, depending on a gap width adjustment of the gap width on the rotary die cutting device used last with the die cutting sheet stored in the memory, the control device is configured to automatically adjust the gap width suitable for the die cutting sheet on the rotary die cutting device now being used.

39. The rotary die cutting system according to claim 38, further comprising a second memory wherein the first and second memories are configured to be at least temporarily linked with each other.

40. A method for adjusting a gap width between a die cutting cylinder and a counter pressure cylinder of a rotary die cutting device of a rotary die cutting system according to claim 24, the method comprising:
reading out the machine-readable information carrier of the die cutting sheet;
determining the gap width suitable for the die cutting sheet; and
adjusting the gap width.

41. The method according to claim 40, wherein in the step of reading out at least one of the elements of the group consisting of an identification of the die cutting sheet, information about a standard gap width, a circumference of a standard die cutting cylinder, a number of teeth of the standard die cutting cylinder, and a toothing of the standard die cutting cylinder is read out.

42. The method according to claim 40, further comprising using a database containing information about one or a plurality of the die cutting sheets.

43. The method according to claim 42, further comprising:
searching the database for information about the die cutting sheet currently employed and the gap width that has been adjusted last for the die cutting sheet currently employed; and
using the gap width stored in the database or using a standard gap width, stored in the information carrier, for adjusting the gap width.

44. The method according to claim 42, further comprising storing a combination of the identification of the currently employed die cutting sheet and of the gap width last used for the currently employed die cutting sheet in the database.

45. The method according to claim 40, further comprising identifying the die cutting cylinder currently employed in the rotary die cutting device.

46. The method according to claim 45, wherein the step of identifying includes automatically making available for each rotary die cutting device at least a stored information for the currently employed die cutting cylinder or selecting manually the die cutting cylinder.

47. The method according to claim 46, wherein the stored information for the currently employed die cutting cylinder includes at least one of the elements selected from the group consisting of a die cutting cylinder diameter, a number of teeth, and a toothing.

48. The method according to claim 45, further comprising comparing a nominal gap width that is stored for the currently employed die cutting cylinder with a standard gap width of the die cutting sheet and, when a difference is determined, determining a required gap width correction.

49. The method according to claim 45, further comprising using a die cutting cylinder-specific driving curve, retrieved from a die cutting cylinder database, for adjusting the gap width.

50. The method according to claim 49, further comprising:
retrieving a control signal for the servomotor required for adjusting the gap width from the die cutting cylinder-specific driving curve; or
determining the control signal for the servomotor by interpolation from neighboring values of the die cutting cylinder-specific driving curve and transmitting the control signal determined by interpolation to the servomotor.

51. The method according to claim 40, further comprising, in the step of determining a gap width, taking into a account a user-defined safety allowance.

52. A die cutting sheet comprising at least one machine-readable information carrier and configured to be used on a rotary die cutting system according to claim 24.
